(19) United States
(12) Patent Application Publication
(10) Pub. No.: US 2012/0327976 A1
(43) Pub. Date: Dec. 27, 2012

(54) Method and Apparatus for Implementing Hybrid Rake/Equalizer Receiver for Spread Spectrum Systems

(76) Inventors: SAIRAMESH NAMMI, Stockholm (SE); NARENDRA TILWANI, Addison, TX (US); PULIN CHHATBAR, Plano, TX (US)

(21) Appl. No.: 13/165,319

(22) Filed: Jun. 21, 2011

(51) Int. Cl. H04B 1/7097

(52) U.S. Cl. 375/148; 375/E01.02; 375/E01.019

(57) ABSTRACT

A UE of a spread spectrum wireless telecommunications system includes a network interface unit which receives multiple path energies of a wireless signal. The UE includes a rake receiver in communication with the network interface unit. The UE includes an equalizer in communication with the network interface unit, either the rake receiver or the equalizer processes the signal based on a predetermined criteria. A method of maintaining performance of a user equipment (UE) in a spread spectrum wireless telecommunications system includes the steps of receiving multiple path energies of a wireless signal at a network interface unit of the UE. There is the step of processing the signal with either a rake receiver of the UE in communication with the network interface unit or an equalizer of the UE in communication with the network interface unit based on a predetermined criteria.

### TECHNICAL FIELD

The present invention is related to user equipment (UE) of a spread spectrum wireless telecommunications system having a rake receiver and an equalizer, either of which processes a received signal based on predetermined criteria. (As used herein, references to the “present invention” or “invention” relate to exemplary embodiments and not necessarily to every embodiment encompassed by the appended claims.) More specifically, the present invention is related to a UE of a spread spectrum wireless telecommunications system having a rake receiver and an equalizer, either of which processes a received signal based on predetermined criteria, where the predetermined criteria is based on the UE's location or based on a change in the signal's signal-to-noise ratio, long term or average.

### BACKGROUND

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

In wireless communication systems, signals propagate over many paths from the transmitter to the receiver. Due to the constructive and destructive addition of these multipath energies fading occurs. When the delay spread is more than the symbol period fading can be termed as frequency selective fading and it causes intersymbol interference (ISI). ISI degrades the system performance. Spread spectrum systems such as CDMA-EVDO, UMTS, HSDPA etc. takes advantage of multipath by learning the channel, then despreading and combining the energy from the resolved paths. Codes are designed to minimize the effect of inter-chip interference (ICI) caused by the multipath. However, when multiple downlink data streams are multiplexed and transmitted via orthogonal codes, multipath destroys orthogonality, creating severe multi-access interference (MAI).

Typical Code Division Multiple Access (CDMA) systems employ a rake receiver to take advantage of multipath. Rake receiver combines the energy from a few strongest paths, without regard to reducing MAI. A chip level equalizer has been proposed to reduce MAI in the bit estimates. Unfortunately, Equalizer complexity is very high and drains lot of battery power.

Table 1 shows the performance comparison of Rake and equalizer for CDMA 1X EV-DO for downlink. It can be seen that the equalizer gives a gain of 33% in sector throughput for Ped-B channel. Though it gives a gain in terms of sector and peak throughput, the performance of equalizer suffers or provides no extra gain at the cell edge.

TABLE 1

| | | |
|---|---|---|
| | Sector | Cell Edge |
| Receiver | Throughput | Throughput |

| Type | In Mbps | % gain | In Kbps | % gain |
|---|---|---|---|---|
| Rake | 0.88 | — | 15.9 | — |
| Receiver | | | | |
| Equalizer | 1.17 | 32.95 | 15.2 | −4.6 |

FIG. 1 shows the user throughput vs. coverage probability for CDMA 1X-EV DO with both Rake receiver and equalizer. It can be seen that equalizer provides an excellent gain when it is at the cell center; gains are up to 150% compared to conventional rake receiver. It can be seen from FIG. 1 that at cell edge (95% coverage probability), there is essentially no gain. FIG. 2 shows a block diagram of a prior art rake receiver. FIG. 3 shows a block diagram of a prior art equalizer.

### BRIEF SUMMARY OF THE INVENTION

The present invention implements a hybrid rake/equalizer at the UE, to reduce the computations while maintaining the same performance of the equalizer.

The present invention pertains to a UE of a spread spectrum wireless telecommunications system. The UE comprises a network interface unit which receives multiple path energies of a wireless signal. The UE comprises a rake receiver in communication with the network interface unit. The UE comprises an equalizer in communication with the network interface unit, either the rake receiver or the equalizer processes the signal based on a predetermined criteria.

The present invention pertains to a method of maintaining performance of a user equipment (UE) in a spread spectrum wireless telecommunications system. The method comprises the steps of receiving multiple path energies of a wireless signal at a network interface unit of the UE. There is the step of processing the signal with either a rake receiver of the UE in communication with the network interface unit or an equalizer of the UE in communication with the network interface unit based on a predetermined criteria.

### BRIEF DESCRIPTION OF THE DRAWING

In the accompanying drawings, the preferred embodiment of the invention and preferred methods of practicing the invention are illustrated in which:

FIG. 1 shows the user throughput vs. coverage probability for CDMA 1X-EV DO with both Rake receiver and equalizer.

FIG. 2 shows a block diagram of a prior art rake receiver.

FIG. 3 shows a block diagram of a prior art equalizer.

FIG. 4 is a flow chart of the algorithm of the present invention.

FIG. 5 shows the block diagram of the hybrid Rake and Equalizer.

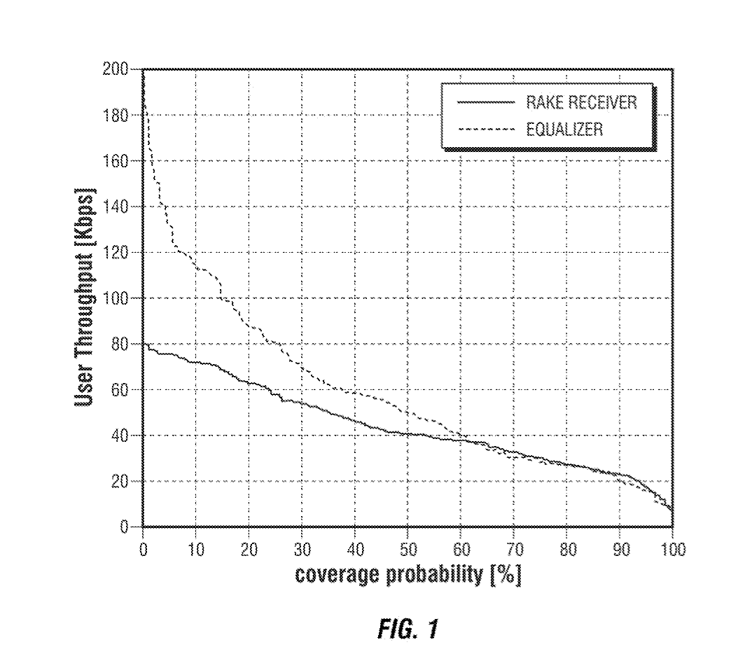

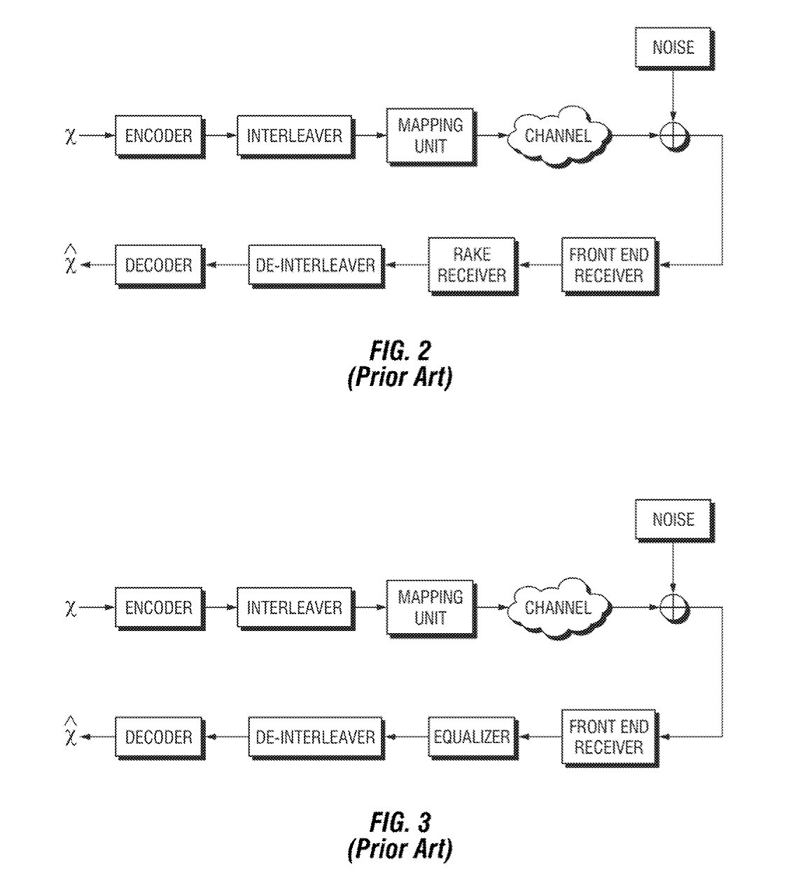

### DETAILED DESCRIPTION

Referring now to the drawings wherein like reference numerals refer to similar or identical parts throughout the several views, and more specifically to FIG. 5 thereof, there is shown a UE 10 of a wireless telecommunications system. The UE 10 comprises a network interface unit 12 which receives multiple path energies of a wireless signal. The UE 10 comprises a rake receiver 14 in communication with the network interface unit 12. The UE 10 comprises an equalizer 16 in communication with the network interface unit 12, either the rake receiver 14 or the equalizer 16 processes the signal based on a predetermined criteria.

Either the equalizer 16 or the rake receiver 14 may be chosen to process the signal based on the UE's 10 location. Either the equalizer 16 or the rake receiver 14 may be chosen to process the signal based on a change in the signal's signal-to-noise ratio, long term or average. For instance, if the long term signal-to-noise ratio (SINR) falls under −4 to 0 dB, this will be considered a change.

The UE 10 may include a switch 20 in communication with the network interface unit 12 and the rake receiver 14 and the equalizer 16, which directs the signal to either the rake receiver 14 or the equalizer 16 for processing. The UE 10 may include a controller 18 which determines a cross correlation of the signal received by the network interface unit 12 with a code sequence and identifies a number of energy peaks in the received signal.

The controller 18 may cause the switch 20 to direct the received signal to the rack receiver to compute an output when the number of peaks is equal to 1. The controller 18 may cause the switch 20 to direct the received signal to the rack receiver to compute the output when the UE 10 is in proximity to a cell edge. The controller 18 may cause the switch 20 to direct the received signal to the equalizer 16 for the equalizer 16 to compute the output when the number of peaks is not equal to I and the UE 10 is not in proximity to the cell edge.

The controller 18 may determine whether the UE is in proximity to the cell edge if over a period of time a downlink pilot SINR regarding the UE 10 is less than a predetermined threshold. A possible range of such thresholds may be −4 to 0 dB. The controller 18 may determine whether the UE 10 is in proximity to the cell edge based on a neighbor list and an associated measurement report.

The present invention pertains to a method of maintaining performance of a user equipment (UE) 10 in a spread spectrum wireless telecommunications system. The method comprises the steps of receiving multiple path energies of a wireless signal at a network interface unit 12 of the UE 10. There is the step of processing the signal with either a rake receiver 14 of the UE 10 in communication with the network interface unit 12 or an equalizer 16 of the UE 10 in communication with the network interface unit 12 based on predetermined criteria.

There may be the step of choosing either the equalizer 16 or the rake receiver 14 to process the signal based on the UE's 10 location. There may be the step of choosing either the equalizer 16 or the rake receiver 14 to process the signal based on a change in the signal's signal-to-noise ratio, long term or average.

There may be the step of directing the signal with a switch 20 of the UE 10 in communication with the network interface unit 12 and the rake receiver 14 and the equalizer 16 to either the rake receiver 14 or the equalizer 16 for processing. There may be the steps of determining with a controller 18 a cross correlation of the signal received by the network interface unit 12 with a code sequence and identifying a number of energy peaks in the received signal.

There may be the step of causing with the controller 18 the switch 20 to direct the received signal to the rack receiver to compute an output when the number of peaks is equal to 1. There may be the step of causing with the controller 18 the switch 20 to direct the received signal to the rack receiver to compute the output when the UE 10 is in proximity to a cell edge. There may be the step of causing with the controller 18 the switch 20 to direct the received signal to the equalizer 16 for the equalizer 16 to compute the output when the number of peaks is not equal to 1 and the UE 10 is not in proximity to the cell edge.

There may be the step of determining with the controller 18 whether the UE 10 is in proximity to the cell edge if over a period of time a downlink pilot SINR regarding the UE 10 is less than a predetermined threshold. There may be the step of determining with the controller 18 whether the UE 10 is in proximity to the cell edge based on a neighbor list and an associated measurement report.

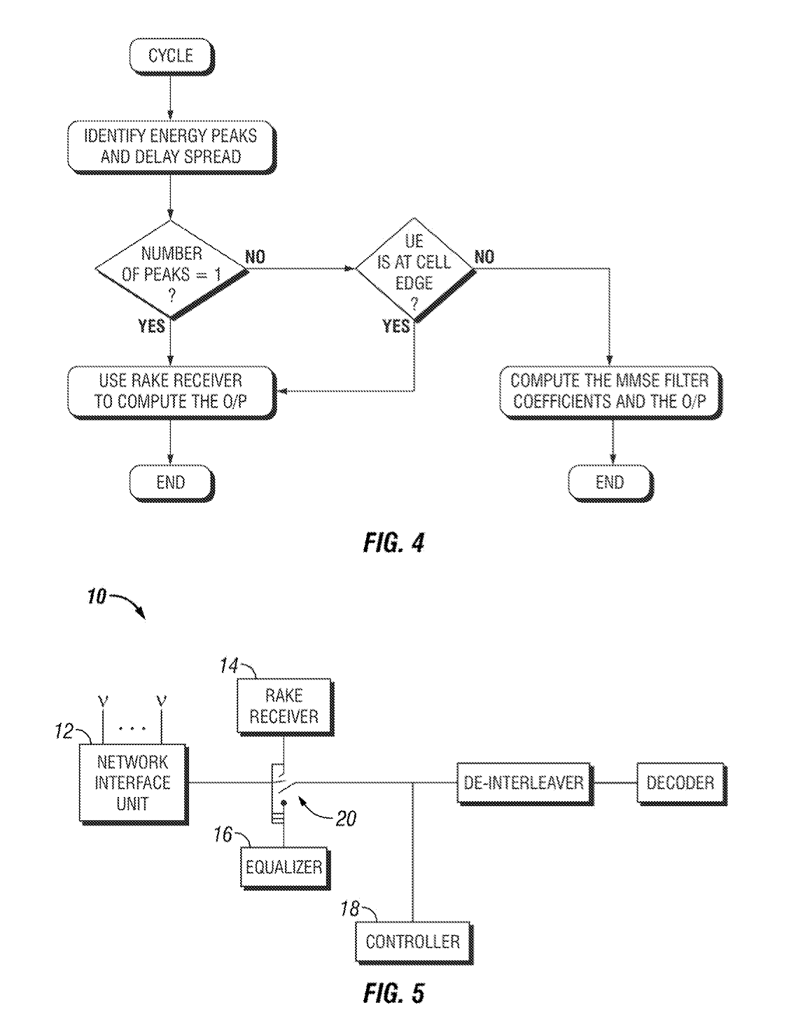

In the operation of the invention, the UE 10 utilizes an algorithm that does not require any standards change. The algorithm is as follows and also shown in FIG. 4:

Algorithm:

Let ‘T’ denote a periodic time at which the cycle starts. Assuming Mobile station computes the correlation.
1. Determine the cross correlation of the received signal with the code sequence and identify the energy peaks in the received signal.
2. If the number of peaks (paths) is equal to 1. Go to Step 4.
3. Compute if the UE 10 is at cell edge. If yes Go Step 4, else Use equalizer 16 to compute the output and Go step 5.
4. Use rake receiver 14 to compute the output.
5. End of the cycle.

Several methods to determine whether the UE 10 is at the cell edge are as follows:

The steps to find out the cell edge are as follows:

Method 1: Based on Downlink Pilot SINR

If it is determined over a period of time the SINR is less than some threshold, it can be concluded that the corresponding UE 10 is at the cell edge.

Method 2: Based on Neighbor List

The logic in using a neighbor list technique is that before the UE 10 wants to handoff, it will send a measurement report (or multiple such reports) which indicates that it is close to the cell boundary and very likely to handoff to other cells. Measurement reports contain information about neighboring eNBs and their RSRP levels as seen by the UE 10. Based on this, it can be determined that it is at the cell edge.

Other methods such as GPS positioning, Mobile positioning, round trip delay could be used to determine the UE 10 location.

FIG. 4 is a flow chart of the algorithm of the present invention.

FIG. 5 shows the block diagram of the hybrid Rake and Equalizer 16. The network interface unit 12 processes the received signals; typical operations involve RF filters, band pass to base band conversion (A/D conversion), etc., as is well known. The controller 18 decides whether the rake receiver 14 should be used or Equalizer 16 should be used based on certain conditions (as explained in the flow chart). Once the received signal is passed through either the rake receiver 14 or equalizer 16, the output bits are passed through de-interleaver and the channel decoder, as is well known.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. User Equipment (UE) of a spread spectrum wireless telecommunications system comprising:
a network interface unit which receives multiple path energies of a wireless signal;
a rake receiver in communication with the network interface unit; and
an equalizer in communication with the network interface unit, either the rake receiver or the equalizer processes the signal based on a predetermined criteria.

2. The UE of claim 1 wherein either the equalizer or the rake receiver is chosen to process the signal based on the UE's location.

3. The UE of claim 1 wherein either the equalizer or the rake receiver is chosen to process the signal based on a change in the signal's signal-to-noise ratio, long term or average.

4. The UE of claim 1 including a switch in communication with the network interface unit and the rake receiver and the equalizer, which directs the signal to either the rake receiver or the equalizer for processing.

5. The UE of claim 1 including a controller which determines a cross correlation of the signal received by the network interface unit with a code sequence and identifies a number of energy peaks in the received signal.

6. The UE of claim 5 wherein the controller causes the switch to direct the received signal to the rack receiver to compute an output when the number of peaks is equal to 1.

7. The UE of claim 5 wherein the controller causes the switch to direct the received signal to the rack receiver to compute the output when the UE is in proximity to a cell edge.

8. The UE of claim 5 wherein the controller causes the switch to direct the received signal to the equalizer for the equalizer to compute the output when the number of peaks is not equal to 1 and the UE is not in proximity to the cell edge.

9. The UE of claim 5 wherein the controller determines whether the UE is in proximity to the cell edge if over a period of time a downlink pilot signal to noise ratio regarding the UE is less than a predetermined threshold.

10. The UE of claim 5 wherein the controller determines whether the UE is in proximity to the cell edge based on a neighbor list and an associated measurement report.

11. A method of maintaining performance of a user equipment (UE) in a spread spectrum wireless telecommunications system comprising the steps of:
receiving multiple path energies of a wireless signal at a network interface unit of the UE; and
processing the signal with either a rake receiver of the UE in communication with the network interface unit or an equalizer of the UE in communication with the network interface unit based on a predetermined criteria.

12. The method of claim 11 including the step of choosing either the equalizer or the rake receiver to process the signal based on the UE's location.

13. The method of claim 11 including the step of choosing either the equalizer or the rake receiver to process the signal based on a change in the signal's signal-to-noise ratio, long term or average.

14. The method of claim 11 including the step of directing the signal with a switch of the UE in communication with the network interface unit and the rake receiver and the equalizer to either the rake receiver or the equalizer for processing.

15. The method of claim 11 including the steps of determining with a controller a cross correlation of the signal received by the network interface unit with a code sequence and identifying a number of energy peaks in the received signal.

16. The method of claim 15 including the step of causing with the controller the switch to direct the received signal to the rack receiver to compute an output when the number of peaks is equal to 1.

17. The method of claim 15 including the step of causing with the controller the switch to direct the received signal to the rack receiver to compute the output when the UE is in proximity to a cell edge.

18. The method of claim 15 including the step of causing with the controller the switch to direct the received signal to the equalizer for the equalizer to compute the output when the number of peaks is not equal to I and the UE is not in proximity to the cell edge.

19. The method of claim 15 including the step of determining with the controller whether the UE is in proximity to the cell edge if over a period of time a downlink pilot SINR regarding the UE is less than a predetermined threshold.

20. The method of claim 15 including the step of determining with the controller whether the UE is in proximity to the cell edge based on a neighbor list and an associated measurement report.
